(19) United States
(12) Patent Application Publication
(10) Pub. No.: US 2018/0116026 A1
(43) Pub. Date: Apr. 26, 2018

(54) Apparatus, System, and Method for a Boost Driven Light Array

(71) Applicant: Mountain Electronics LLC, South Jordan, UT (US)

(72) Inventor: Richard Mark McDougal, West Jordan, UT (US)

(21) Appl. No.: 15/790,994

(22) Filed: Oct. 23, 2017

Related U.S. Application Data
(60) Provisional application No. 62/411,607, filed on Oct. 22, 2016.

(51) Int. Cl. H05B 33/08; H05B 37/02

(52) U.S. Cl. CPC H05B 33/0848; H05B 37/02

(57) ABSTRACT

A system for a boost driven light array. The light array includes a boost converter, a light array, and a driver. The boost converter includes a boost circuit configured to output an output voltage higher than an input voltage. The light array includes a plurality of light emitters. The driver is electrically connected to the boost converter and the light array. The driver includes a dimmer controller configured to regulate a power provided to the light array.

### CROSS-REFERENCE TO RELATED APPLICATIONS

This application claims the benefit of U.S. Provisional Patent Application No. 62/411,607, entitled “Apparatus, System, and Method for a Boost Driven Light Array,” which was filed on Oct. 22, 2017, which is hereby incorporated by reference.

### SUMMARY

An embodiment of the invention provides a system for a boost driven light array. The system for a boost driven light array includes a boost converter, a light array, and a driver. The boost converter includes a boost circuit configured to output an output voltage higher than an input voltage. The light array includes a plurality of light emitters. The driver is electrically connected to the boost converter and the light array. The driver includes a dimmer controller configured to regulate a power provided to the light array. Other embodiments are also described

### BRIEF DESCRIPTION OF THE SEVERAL VIEWS OF THE DRAWINGS

FIG. 1 is a block diagram depicting one embodiment of a system for a boost driven light array.

FIG. 2 is a block diagram depicting an embodiment of the boost converter of FIG. 1.

FIG. 3 is a block diagram depicting an embodiment of the driver of FIG. 1.

FIG. 4 is a block diagram depicting an embodiment of the light array of FIG. 1.

FIG. 5 is a front view depicting one embodiment of a light array.

FIG. 6 is a block diagram depicting one embodiment of a system for a boost driven light array.

FIG. 7 is a schematic diagram depicting one embodiment of the boost converter of FIG. 6.

FIG. 8 is a schematic diagram depicting one embodiment of the driver of FIG. 6.

FIG. 9 is a schematic diagram depicting one embodiment of the temperature sensor of FIG. 6.

FIG. 10 depicts a flowchart diagram showing an embodiment of a method for manufacturing a boost driven light array.

FIG. 11 is a diagram of one embodiment of a computer system for facilitating the execution of the driver of FIG. 1.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments provide boost driven light array.

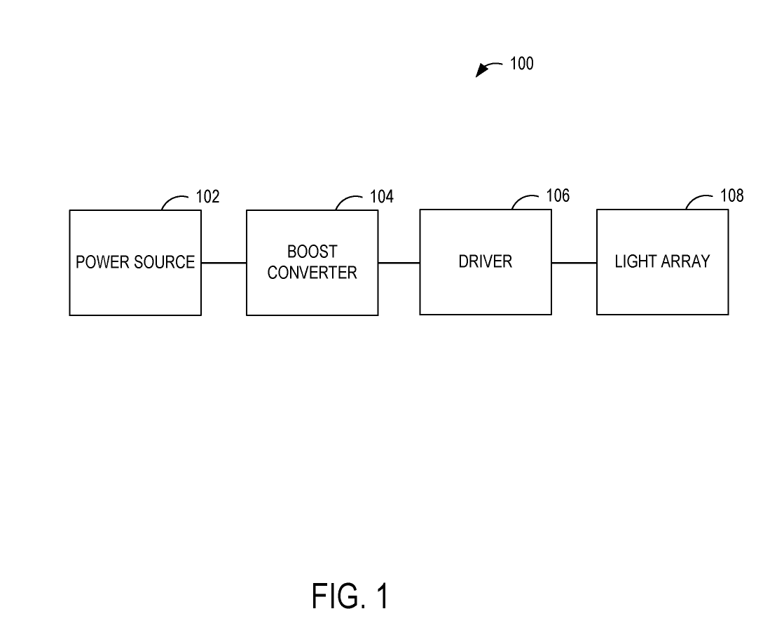

FIG. 1 is a block diagram depicting one embodiment of a system 100 for a boost driven light array. The system 100 includes a power source 102, a boost converter 104, a driver 106, and a light array 108. The system 100 uses power from the power source 102 to provide light output from the light array 108.

The power source 102, in some embodiments, provides electrical power to drive the system 100. The power source 102 may be any type of electrical power source. For example, the power source 102 may be a battery or a plurality of batteries. In this example, the battery or plurality of batteries may provide a direct current (“DC”) voltage, such as 12 volts DC. As will be appreciated by one skilled in the art, the voltage provided by the battery or plurality of batteries in this example may be any voltage typically provided by a battery, and the voltage provided may vary as power is delivered from the battery.

In another example, the power source 102 is an electric generator, such as a dynamo or an alternator. For example, the power source 102 may be an alternator driven by an automobile engine.

The boost converter 104, in one embodiment, converts the electrical power provided by the power source 102 to a predetermined voltage. In some embodiments, the boost converter 104 increases a voltage provided by the power source 102. For example, the boost converter 104 may convert a 12 volt DC input to 50 volt DC output. In some embodiments the boost converter 104 converts an input between 11 volts and 40 volts DC to a predetermined output. In certain embodiments, the boost converter 104 has a predetermined output voltage between 12 volts DC and 90 volts DC. In one embodiment, the boost converter 104 converts an AC input to a DC output.

In some embodiments, the boost converter 104 is configured to provide a predetermined amount of electrical power at a predetermined voltage. Electric power is defined as follows:

P=VI

where P is power, V is voltage, and I is current. In one example, the boost converter 104 is configured to output 50 volts, 6 amps for a power output of 300 watts.

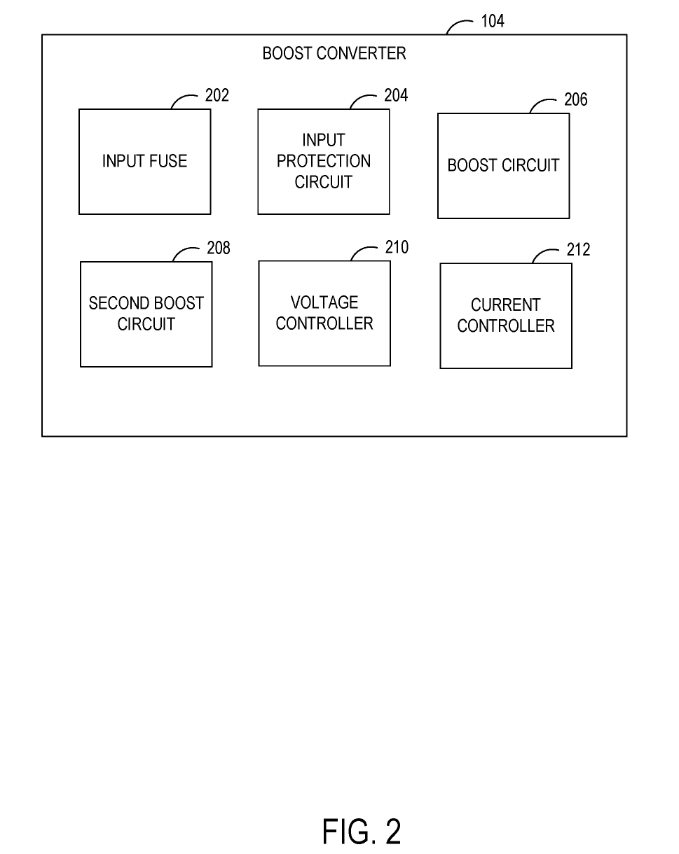

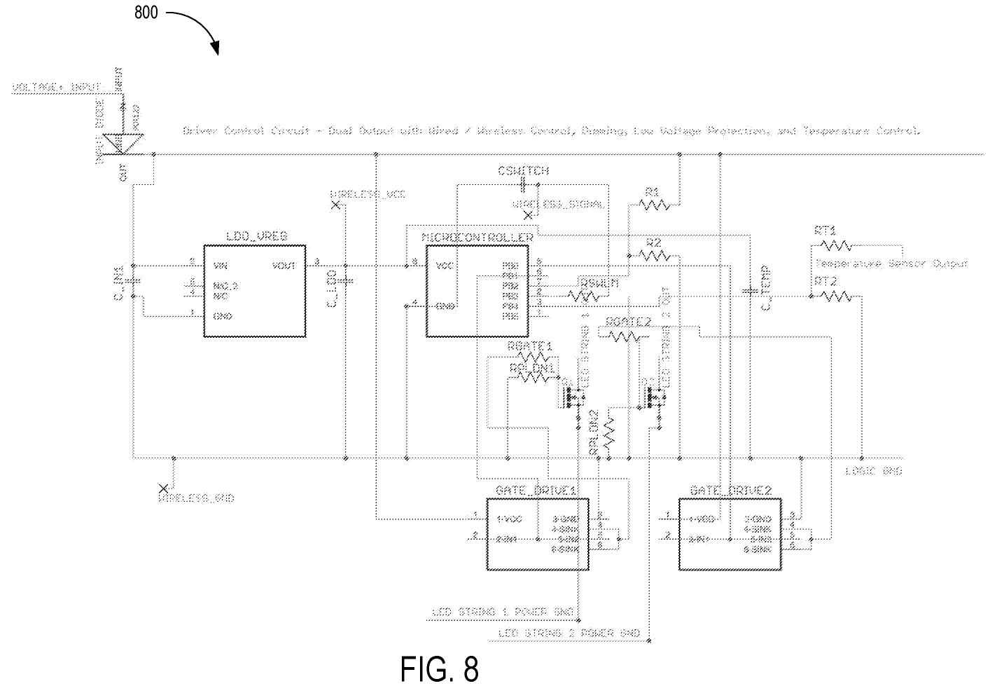

The boost converter 104 is described in greater detail below in relation to FIGS. 2 and 8.

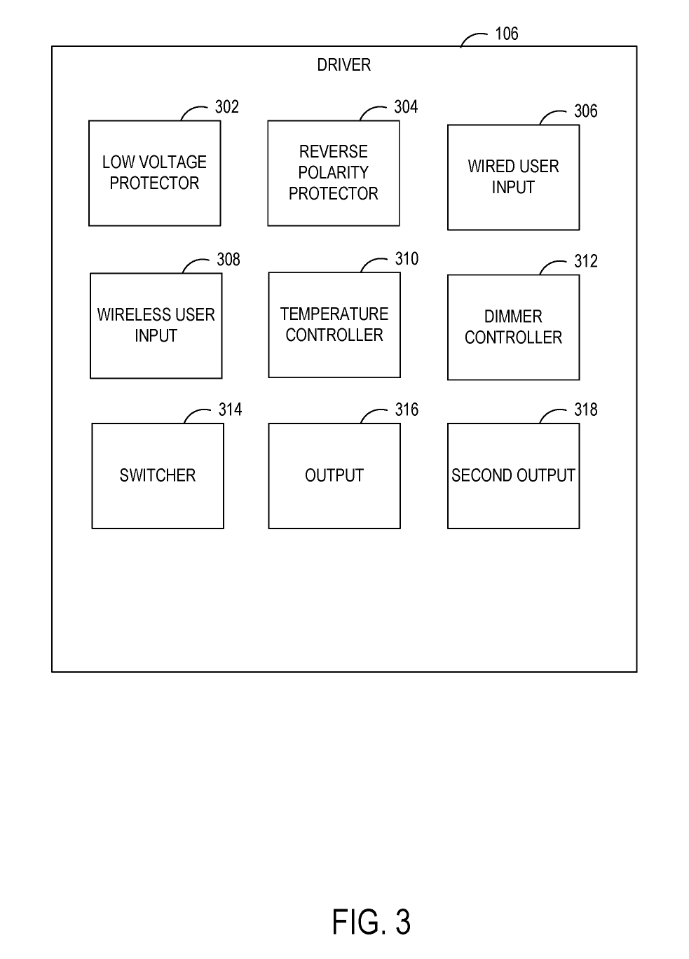

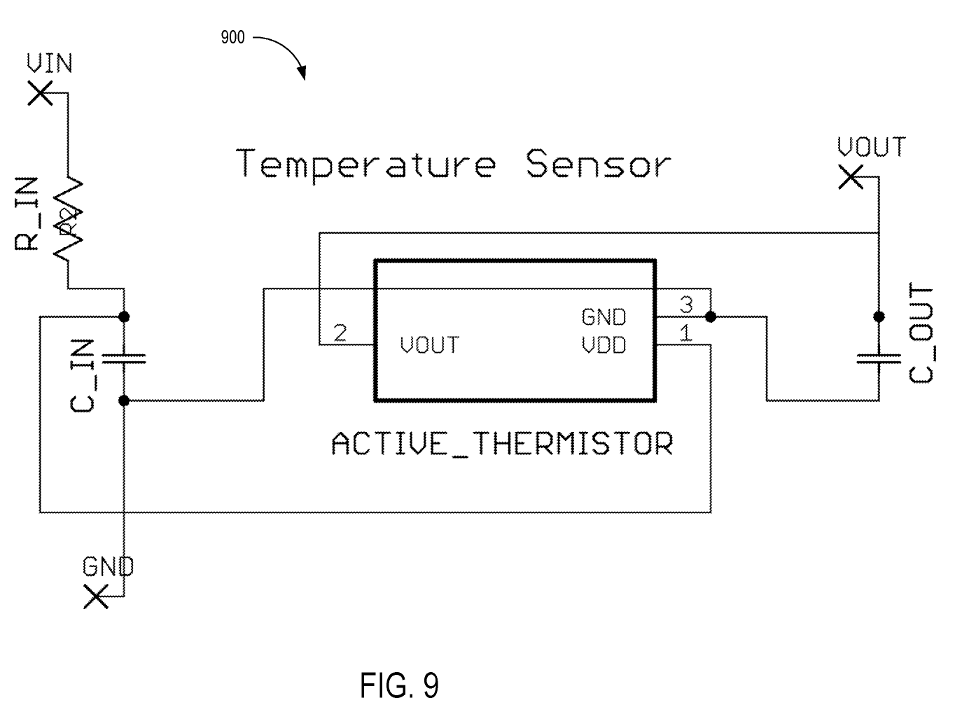

The driver 106, in some embodiments, manages the output of the boost converter 104 and receives input to determine the power to provide to the light array 108. The driver 106 may include inputs to activate or deactivate the light array 108, to change the output of the light array 108, or to manage a temperature of the light array 108. The driver 106 is described in greater detail below in relation to FIGS. 3 and 9.

FIG. 2 is a block diagram depicting an embodiment of the boost converter 104 of FIG. 1. The boost converter 106 includes an input fuse 202, an input protection circuit 204, a boost circuit 206, a second boost circuit 208, a voltage controller 210, and a current controller 212. The boost converter 104 modifies an electrical input provided by the power source 102.

The input fuse 202, in one embodiment, provides overcurrent protection to the boost converter 104 from electric power provided by the power source 102. The input fuse 202 may stop power provided by the power source 102 to the boost converter 104 in response to a current associated with the power exceeding a predetermined threshold. For example, the input fuse 202 may be a 20 amp fuse.

The input fuse 202 may have any amperage rating. For example, the input fuse 202 may be a 40 amp fuse, a 10 amp fuse, or a 15 amp fuse. The input fuse 202 may also be a plurality of fuses connected in parallel. In one embodiment, the input fuse is a resettable circuit breaker.

The input protection circuit 204, in some embodiments, protects the boost converter 104 from input electric power that does not comply with predetermined parameters. The input protection circuit 204 may limit the transmission of power that does not comply with the predetermined parameters. The input protection circuit 204 may include voltage protection, polarity protection, current protection, or other types of protection. For example, the input protection circuit 204 may restrict transmission of power that has reversed polarity.

In another example, the input protection circuit 204 may restrict transmission of power that has a voltage above a predetermined value. In a similar example, the input protection circuit 204 may restrict transmission of power that has a voltage below a predetermined value. In one embodiment, the input protection circuit 204 restricts transmission of power unless the input power is between 11 volts and 40 volts.

In another example, the input protection circuit 204 may restrict transmission of power that has a current above a predetermined value. In a similar example, the input protection circuit 204 may restrict transmission of power that has a current below a predetermined value. In one embodiment, the input protection circuit 204 restricts transmission of power unless the input current is below 30 amps.

The boost circuit 206, in one embodiment, increases the voltage provided by the power source 102. Increasing the voltage allows the system 100 to provide a similar amount of power from the driver 106 to the light array 108 using a lower current than would be possible using the voltage provided by the power source 102.

The boost circuit 206 may be any type of boost converter circuit known in the art. For example, the boost circuit 206 may include a diode, a transistor, and an energy storage component such as an inductor or a capacitor. The components of the boost circuit may include a switch and be configured as a switched-mode power supply to boost the voltage provided by the power source 102.

The switch in the boost circuit 206 may be any suitable switch, such as a power metal-oxide-semiconductor field-effect transistor (“MOSFET”) or a bipolar power transistor. In some embodiments, the switch in the boost circuit 206 is an element of an integrated circuit.

In certain embodiments, the boost converter 104 includes the second boost circuit 208. The second boost circuit 208 provides an independent, boosted power source for driving one or more elements of the light array 108. The second boost circuit 208 may have output characteristics, such as voltage and amperage, similar to or different from the output characteristics of the first boost circuit 206. The second boost circuit 206, in one embodiment, includes components similar to those in the boost circuit 204. Other components of the boost converter 104, such as the input fuse 202, the voltage controller 210 and the current controller 212 may operate to modify the operation of the second boost circuit 208 in a similar manner to their operation on the boost circuit 206. The operation of these components in relation to the second boost circuit 208 may be independent to their operation in relation to their operation in relation to the boost circuit 206.

The voltage controller 210, in one embodiment, controls an output voltage of the boost circuit 206. The voltage controller 210 may regulate the output voltage of the boost circuit 206 at a predetermined voltage. The voltage controller 210 may be configured to receive the output of the boost circuit 206 to provide a feedback for the voltage controller 210 to manage the boost circuit 206. In some embodiments, the voltage controller 210 manages operation of the switch in the boost circuit 206 to control output voltage. In some embodiments, the predetermined voltage is adjustable in response to an input by a user. In some embodiments, the voltage controller in the boost circuit 206 is an element of an integrated circuit.

For example, the voltage controller 210 may configured to cause the boost circuit 206 to have a 50 volt output. In another example, the voltage controller may be adjustable by a user to regulate the boost circuit 206 to any voltage between 12 volts and 90 volts. In yet another example, the voltage controller may determine an output voltage of the boost circuit 206 and adjust a rate of switching or duty cycle of the switch in the boost circuit 206 to modify the output voltage.

The current controller 212, in some embodiments, controls an output current of the boost circuit 206. The current controller 212 may regulate the output current to a predetermined current. In some embodiments, the current controller 212 is configured to sample the output to provide feedback to the current controller 212. The predetermined current of the current controller 212 may be modified in response to an input from a user in some embodiments. In one example, the current controller 212 may be configured to maintain a constant current of 6 amps. In some embodiments, the current controller 212 is an element of an integrated circuit.

In certain embodiments, the voltage controller 210 and the current controller 212 operate in response to changing conditions of the light array 108. For example, in some embodiments, a forward voltage (V_{f}) of the light array 108 or of elements of the light array 108 may change as the temperature of the light array 108 changes. In this example, the forward voltage of the light array 108 may decrease as the temperature of the light array 108 increases under operation. The voltage controller 210 may operate to increase the output voltage when the light array 108 is relatively cold and the forward voltage is relatively high. The current controller 212 may operate to restrict or maintain the output current when the light array 108 is relatively hot and the forward voltage is relatively low.

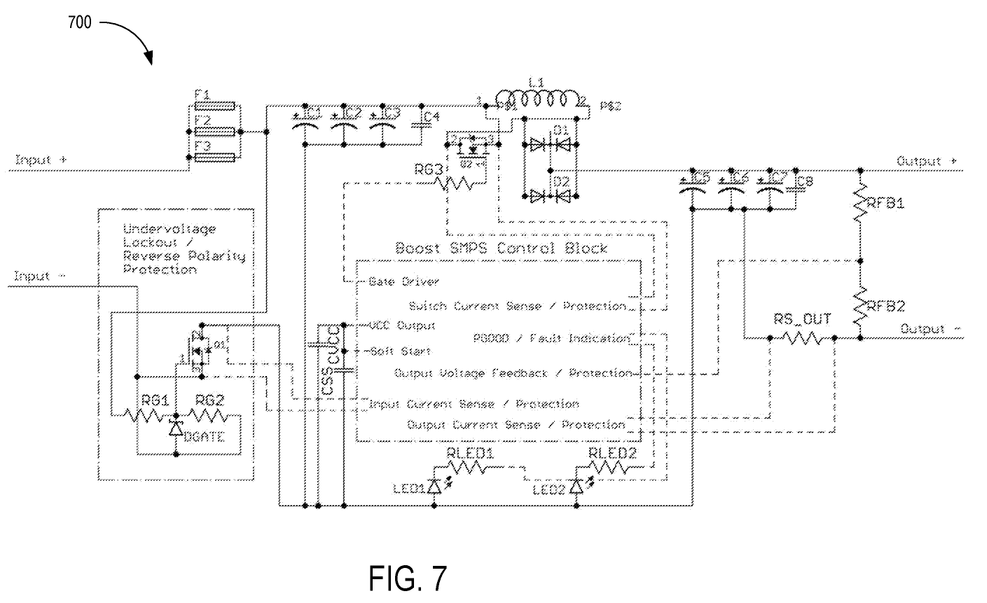

One example of a schematic for a boost converter 104 is described below in relation to FIG. 7.

FIG. 3 is a block diagram depicting an embodiment of the driver 106 of FIG. 1. The driver 106 includes a low voltage protector 302, a reverse polarity protector 304, a wired user input 306, a wireless user input 308, a temperature controller 310, a dimmer controller 312, a switcher 314, an output 316, and a second output 318. The driver 106 manages the power delivered from the boost converter 104 to the light array 108.

The low voltage protector 302, in one embodiment, restricts output of power from the driver 106 that is below a predetermined voltage. In some embodiments, the low voltage protector 302 switches the output 316 off in response to detecting that the voltage is below the predetermined value. In certain embodiments, the predetermined value is settable by a user.

The reverse polarity protector 302, in some embodiments, restricts output of power from the driver 106 in response to detecting that the light array 108 is connected to the driver 106 with the polarity reversed. In one embodiment, the reverse polarity protector 302 detects one or more characteristics of the light array 108, such as resistance, to determine the polarity of the connected light array 108.

In one embodiment, the reverse polarity protector 302 restricts input of power from the boost converter 104 to the driver 106 in response to detecting that the boost converter 104 is connected to the driver 106 with the polarity reversed. In one embodiment, the reverse polarity protector 302 detects one or more characteristics of the power received from the boost converter 104, such as voltage, to determine the polarity of the connected boost converter 104.

The wired user input 306, in one embodiment, receives an input from a user via a wired connection. For example, the wired user input 306 may be responsive to a button (not shown) connected by wire to the wired user input 306. The wired user input 306 may provide a signal to components of the driver 106 in response to an interaction by a user with the button. The driver 106 may process this input to modify the power at the output 316, and therefore modify the response of the light array 108.

In certain embodiments, the wireless user input 308 includes a wireless receiver configured to receive a wireless signal and provide a signal to components of the driver 106 in response to an interaction by a user with a wireless transmitter (not shown). The driver 106 may process this input to modify the power at the output 316, and therefore modify the response of the light array 108.

The temperature controller 310, in some embodiments, receives an input that is responsive to a temperature of a component of the system 100. In one embodiment, the light array 108 includes a temperature sensor that delivers a signal to the temperature controller 310. The temperature controller 310 may modify the output power of the driver 106 in response to a signal that indicates that the temperature sensor has reached or exceeded a predetermined temperature. For example, the temperature controller may interact with the dimmer controller 312 to reduce the power provided to the light array 108. In some embodiments, the temperature controller 310 may cause the driver 106 to deliver no power to the light array 108 in response to a signal that indicates the temperature of the temperature sensor has reached or exceeded a predetermined temperature.

In some embodiments, the dimmer controller 312 restricts the power delivered to the light array 108. The dimmer controller 312 may reduce the power provided to the light array 108 in response to a user input. For example, a user may interact with a button in a manner that directs the dimmer controller 312 to reduce the apparent light output of the light array 108. In another example, the dimmer controller 312 may respond to a signal provided by the temperature controller to reduce the output power.

The dimmer controller 312 may restrict the power using any method known in the art. For example, in one embodiment, the dimmer controller 312 uses pulse width modulation (“PWM”) to restrict the power provided to the light array 108. In one example, the dimmer controller uses a dimming frequency of 19.2 kHz.

The switcher 314, in one embodiment, switches output power between multiple outputs. The switcher 314 may operate in response to a user input. For example, a user may interact with a button in a way that indicates that the driver 106 should provide power to the output 316 and should not provide power to the second output 318. In one embodiment, the switcher may provide some or all of the power that would otherwise go to the second output 318 to the output 316. For example, the switcher 314 may respond to a user input to switch power from the second output 318 to be combined with power provided at the output 316. In this example, the power provided by the output 316 may be effectively doubled if the power previously provided by the second output 318 is similar to the power previously provided at the output 316.

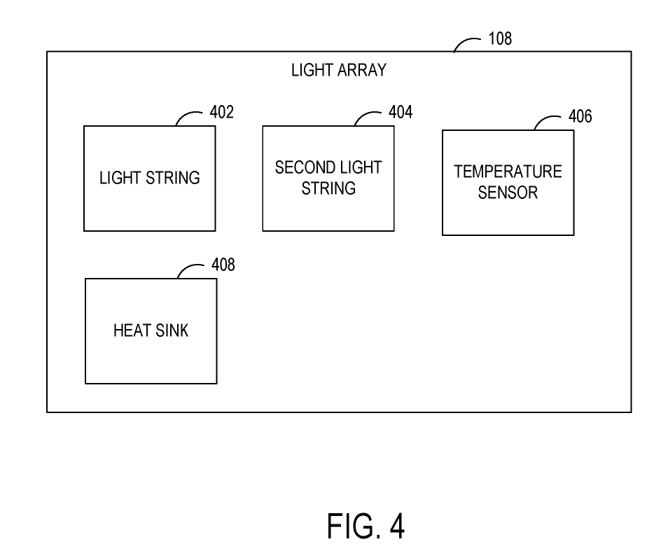

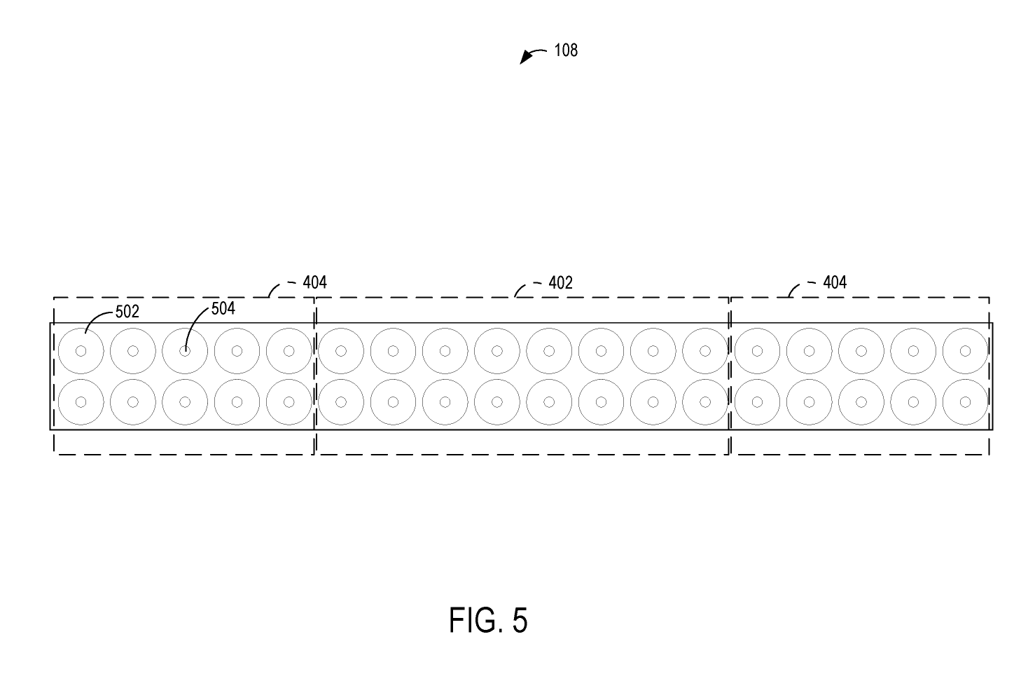

The output 316 provides power to elements of the light array 108. In some embodiments, the second output 318 provides power to elements of the light array 108. The operation of the second output 318 is described in greater detail in relation to FIGS. 4 and 5 below.

FIG. 4 is a block diagram depicting an embodiment of the light array 108 of FIG. 1. The light array 108 includes a first light string 402, a second light string 404, a temperature sensor 406, and a heat sink 408. The light array 408 converts electric power into light.

The light string 402, in one embodiment, includes one or more light emitting components. For example, the light string 402 may include a plurality of light emitting diodes (“LEDs”) connected in series. In another example, the light string 402 includes a plurality of LEDs connected in parallel. In yet another example, the light string 402 includes a plurality of LEDs connected in series (“first substring”) connected in parallel with a second plurality of LEDs connected in series (“second substring”). The light emitting components may be any known light emitters, including LEDs, halogen lamps, high-intensity discharge (“HID”) lamps, incandescent lamps, or the like.

In one embodiment, the light string 402 receives power from the output 316 of the driver 106. The light string 402, in one embodiment, is configured to have electrical characteristics that are appropriate for the power provided by the output 316. For example, LEDs may be arranged in strings (e.g. in series, in parallel, or with a plurality of series substrings arranged in parallel) that have a composite forward voltage that is efficient for use with the power provided by the output 316.

A light emitter in the light string 402 may be disposed relative to a reflector. The reflector may reflect light emitted by the light emitter in a desired direction. The reflector may take the form of a reflective surface. In an alternate embodiment, the light emitter in the light string may be disposed relative to an optic that refracts light from the light emitter in a desired direction. For convenience the term “reflector” as used below may refer to a reflective surface or a refractive optic.

In certain embodiments, the reflector may be configured to disperse light from the light emitter over a relatively wide angle. Such a reflector may be said to be a “flood” reflector. In some embodiments, a reflector is configured to disperse light from the light emitter over a relatively narrow angle. Such a reflector may be said to be a “throw” reflector. In addition, a dispersion angle of light may be impacted by a position of the light emitter relative to the reflector.

In some embodiments, the light array 108 includes a single light string 402. In some embodiments, the light array 108 includes the second light string 404. The second light string 404 receives power from the second output 318 of the driver 108. The second light string 404 may be similar to and have similar components to the light string 402.

In one embodiment, the second light string 404 receives power from the second output 318 similar to the power received by the light string 402 from the output 316. In some embodiments, the light string 402 and the second light string 404 receive different amounts of power from the driver 106. For example, the driver 106 may provide power to the light string 402 and no power to the second light string 404 in response to an input.

In one embodiment, the light string 402 and the second light string 404 have dissimilar reflectors or reflector configurations. For example, the light string 402 may have a preponderance of reflectors configured for flood light dispersal and the second light string 404 may have a preponderance of reflectors configured for throw light dispersal. In this example, the driver may respond to an input from a user to divert power from the light string 402 to the second light string 404 to increase the power to light emitters configured to disperse light over a relatively narrow angle. By providing more power to the light emitters configured to throw light, the light array 108 may illuminate relatively distant objects more efficiently.

The temperature sensor 406, in one embodiment, senses a temperature of the light array 108. The temperature sensor 406 may be attached to a component of the light array 108. In another embodiment, the temperature sensor 406 includes one or more components directly attached to a substrate onto which one or more light emitters are attached. In some embodiments, the temperature sensor 406 includes an active thermistor.

The heat sink 408 is configured to disperse heat generated by light emitters into the environment. The heat sink 408 may take any configuration known to disperse heat, including, but not limited to, a plurality of metal fins.

In certain embodiments, the light emitters are thermally connected to the heat sink via a relatively efficient thermal conduction path. For example, the light emitters may be attached to a metal substrate wherein a metal thermal pad is in contact with the light emitter. The metal substrate may be in thermal contact with the heat sink 408. In some embodiments, the thermal path between the light emitter and the heat sink 408 is entirely or substantially metallic. In some embodiments, relatively thermally efficient paste may be used between components to improve heat transfer efficiency. In one embodiment the temperature sensor 406 is disposed on a metal element within the thermal path between the light emitter and the heat sink 408.

FIG. 5 is a front view depicting one embodiment of a light array 108. The light array 108 includes a light string 402, a second light string 404, a plurality of reflectors 502, and a plurality of light emitters 504. The light array 108 produces directed light.

The light string 402 and the second light string 404 are similar to same-numbered elements described above in relation to FIG. 4. Each of the light string 402 and the second light string 404 includes a plurality of light emitters 504 disposed on a substrate. The plurality of light emitters 504 are each situated near one of the plurality of reflectors 502.

In some embodiments, the light emitters 504 are arranged into an array arrangement. The light emitters associated with one of the light string 402 and the second light string 404 may be contiguous within the array, as are the light emitters 504 in the light string 402 in the illustrated embodiment. The light emitters associated with one of the light string 402 and the second light string 404 may include one or more non-contiguous groupings within the array, as are the light emitters 504 in the second light string 404 in the illustrated embodiment.

In one embodiment, the light string 402 and the second light string 404 are independently controllable by the driver 106. The driver 106 may be operated to power one of the light string 402 and the second light string 404 or both of the light string 402 and the second light string 404.

In one embodiment, the light string 402 includes light emitters 504 that are associated with reflectors 502 configured to provide a flood type dispersion of light, and the second light string 404 includes light emitters 504 associated with reflectors 502 that are configured to provide a throw type dispersion of light. The driver 106, in this example, may respond to a user input to channel power to both the light string 402 and the second light string 404 simultaneously. The driver 106, in this example, may respond to a user input to channel power to one of the light string 402 and the second light string 404 while channeling less or no power to the other of the light string 402 and the second light string 404. In some embodiments, the driver is configured to provide more maximum power to one of the light string 402 and the second light string 404 than either would receive when both of the light string 402 and the second light string 404 are powered. Thus, the driver 106, in this example, may cause additional light to be delivered by the light array 108 in a flood type dispersion or a throw type dispersion in response to a user input.

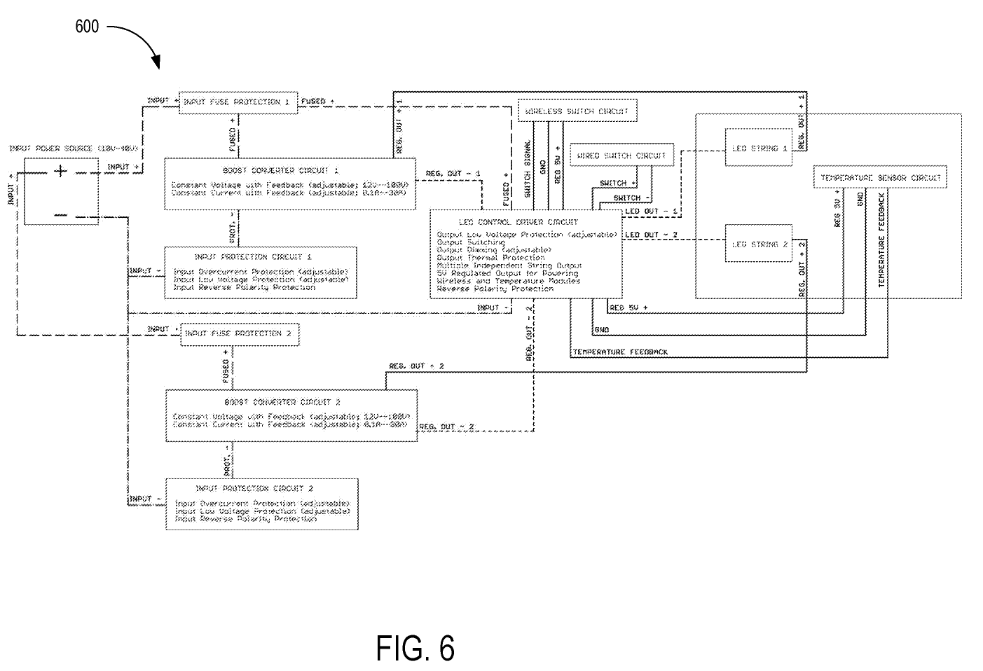

FIG. 6 is a block diagram depicting one embodiment of a system 600 for a boost driven light array. The system 600 includes elements similar to those described above in relation to FIGS. 1-6.

FIG. 7 is a schematic diagram 700 depicting one embodiment of the boost converter shown in the system 600 of FIG. 6. The schematic diagram 700, in one embodiment, includes elements similar to embodiments of the boost converter 104 described in in relation to FIG. 2 above.

FIG. 8 is a schematic diagram 800 depicting one embodiment of the driver shown in the system 600 of FIG. 6. The schematic diagram 800, in one embodiment, includes elements similar to embodiments of the driver 106 described in in relation to FIG. 3 above.

FIG. 9 is a schematic diagram 900 depicting one embodiment of the temperature sensor shown in the system of FIG. 6. The schematic diagram 900, in one embodiment, includes elements similar to embodiments of the temperature sensor 406 described in in relation to FIG. 4 above.

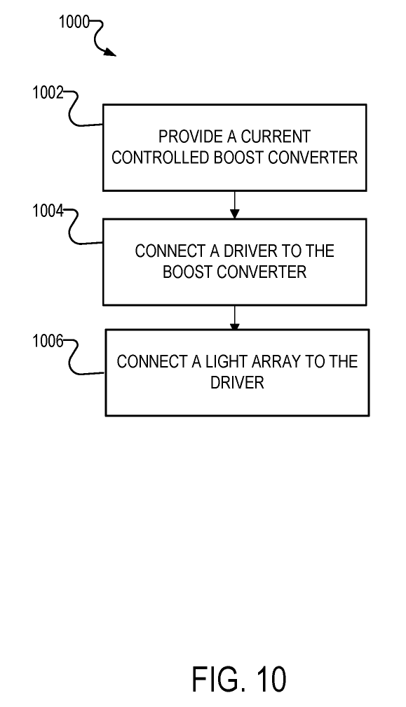

FIG. 10 depicts a flowchart diagram showing an embodiment of a method 1000 for manufacturing a boost driven light array. The method 1000 is in certain embodiments a method of use of the system and apparatus of FIGS. 1-9, and will be discussed with reference to those figures. Nevertheless, the methods may also be conducted independently thereof and are not intended to be limited specifically to the specific embodiments discussed above with respect to those figures.

FIG. 10 illustrates the method 1000 for manufacturing a system 100 for a boost—driven light array. As shown in FIG. 10, current controlled boost converter 104 is provided 1002. The boost converter 104 may include a current controller 212 and a voltage controller 210. In some embodiments, the boost converter 104 includes a second boost circuit 208. In one embodiment, the boost converter 204 includes an input protection circuit 204.

The boost controller 104 is connected 1004 to a driver 106. The boost controller 104 may be connected 1004 to the driver 106 electrically using any known method. For example, the boost controller 104 may be connected 1004 to the driver 106 using electrical connectors associated with each of the boost controller 104 and the driver 106.

The driver 106 is connected 1006 to a light array 108. The light array 108 may be connected 1006 to the driver 106 electrically using any known method. For example, the light array 108 may be connected 1004 to the driver 106 using electrical connectors associated with each of the light array 108 and the driver 106.

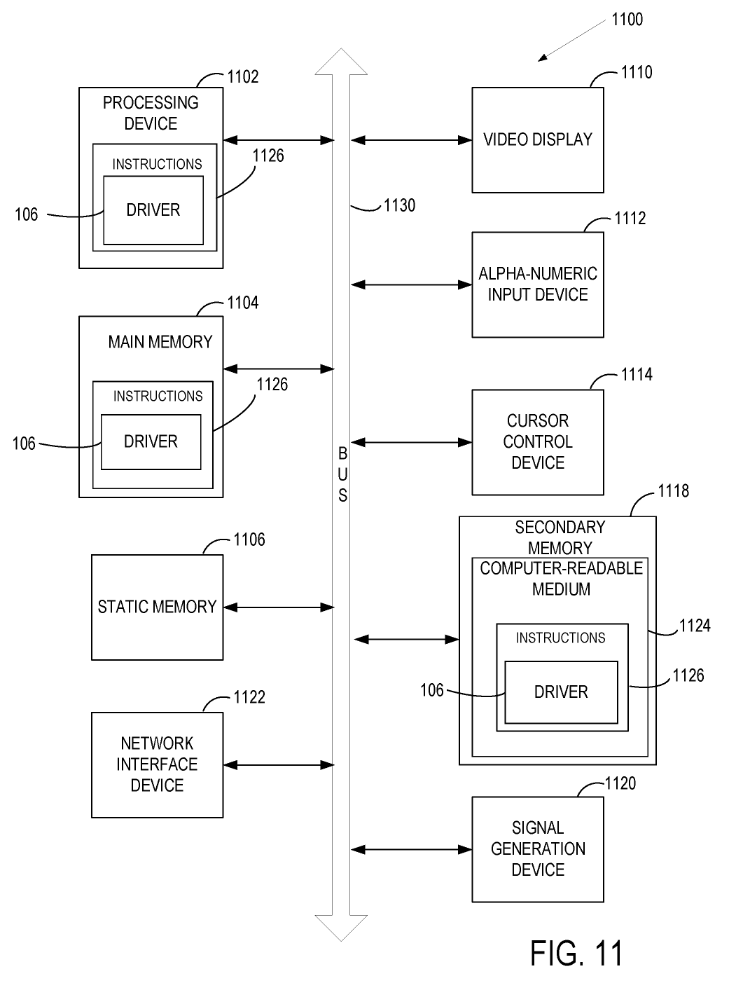

FIG. 11 is a diagram of one embodiment of a computer system 1100 for facilitating the execution of the driver 106 of FIG. 1. Within the computer system 1100 is a set of instructions for causing the machine to perform any one or more of the methodologies discussed herein. In alternative embodiments, the machine may be connected (e.g., networked) to other machines in a LAN, an intranet, an extranet, or the Internet. The machine can be a host in a cloud, a cloud provider system, a cloud controller or any other machine. The machine can operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1100 includes a processing device 1102, a main memory 1104 (e.g., read-only memory (ROM), flash memory, dynamic random access memory (DRAM) such as synchronous DRAM (SDRAM) or DRAM (RDRAM), etc.), a static memory 1106 (e.g., flash memory, static random access memory (SRAM), etc.), and a secondary memory 1118 (e.g., a data storage device in the form of a drive unit, which may include fixed or removable computer-readable storage medium), which communicate with each other via a bus 1130.

Processing device 1102 represents one or more general-purpose processing devices such as a microprocessor, central processing unit, or the like. More particularly, the processing device 1102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. Processing device 1102 is configured to execute the instructions 1126 for performing the operations and steps discussed herein.

The computer system 1100 may further include a network interface device 1122. The computer system 1100 also may include a video display unit 1110 (e.g., a liquid crystal display (LCD) or a cathode ray tube (CRT)) connected to the computer system through a graphics port and graphics chipset, an alphanumeric input device 1112 (e.g., a keyboard), a cursor control device 118 (e.g., a mouse), and a signal generation device 1120 (e.g., a speaker).

The secondary memory 1118 may include a machine-readable storage medium (or more specifically a computer-readable storage medium) 1124 on which is stored one or more sets of instructions 1126 embodying any one or more of the methodologies or functions described herein. In one embodiment, the instructions 1126 include instructions for the driver 106. The instructions 1126 may also reside, completely or at least partially, within the main memory 1104 and/or within the processing device 1102 during execution thereof by the computer system 1100, the main memory 1104 and the processing device 1102 also constituting machine-readable storage media.

The computer-readable storage medium 1124 may also be used to store the instructions 1126 persistently. While the computer-readable storage medium 1124 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The instructions 1126, components and other features described herein can be implemented as discrete hardware components or integrated in the functionality of hardware components such as ASICS, FPGAs, DSPs or similar devices. In addition, the instructions 1126 can be implemented as firmware or functional circuitry within hardware devices. Further, the instructions 1126 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “providing,” “generating,” “installing,” “monitoring,” “enforcing,” “receiving,” “logging,” “intercepting,” “computing,” “calculating,” “determining,” “presenting,” “processing,” “confirming,” “publishing,” “receiving,” “applying,” “detecting,” “selecting,” “updating,” “assigning,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. In addition, unless specifically stated otherwise as apparent from the following discussion, it is appreciated that throughout the description, discussions utilizing terms such as “manager,” “receiver,” “generator,” “tracker,” “biaser,” “calculator,” “associator,” detector,” “publisher,” or the like, refer to processes operating on a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for a boost driven light array comprising:
a boost converter comprising a boost circuit configured to output an output voltage higher than an input voltage;
a light array comprising a plurality of light emitters; and
a driver electrically connected to the boost converter and the light array, the driver comprising a dimmer controller configured to regulate a power provided to the light array.

2. The system of claim 1, wherein the output voltage is predetermined.

3. The system of claim 2, wherein the predetermined output voltage is between 12 V DC and 90 V DC.

4. The system of claim 2, wherein the predetermined output voltage is 50 V DC.

5. The system of claim 1, wherein the boost circuit comprises a switched mode power supply.

6. The system of claim 1, wherein the boost converter comprises a current controller configured to maintain an output current of the boost converter to a predetermined current.

7. The system of claim 1, wherein the boost converter further comprises an input protection circuit configured to restrict electrical input to the boost circuit in response to a characteristic of input electricity failing to meet a predetermined parameter, wherein the predetermined parameter is selected from the group consisting of a minimum input voltage, a maximum input voltage, a minimum input current, a maximum input current, and an input polarity.

8. The system of claim 1, further comprising a second boost circuit configured to output a second output voltage higher than the input voltage.

9. The system of claim 8, wherein the light array comprises:
a light string comprising a plurality of LED emitters, the light string connected to the boost converter; and
a second light string comprising a second plurality of LED emitters, the second light string electrically connected to the second boost circuit.

10. The system of claim 9, wherein a power provided to the light string and a second power provided to the second light string are controlled independently by the driver.

11. The system of claim 1, wherein the driver comprises a user input configured to receive a signal from a user to modify operation of the driver.

12. The system of claim 11, wherein the user input is a wired user input.

13. The system of claim 11, wherein the driver comprises a wireless receiver and the user input is a wireless user input received by the wireless receiver.

14. The system of claim 1, wherein the light array comprises a temperature sensor and the driver comprises a temperature controller, and wherein the temperature controller regulates the power provided to the light array in response to an input from the temperature sensor.

15. A light array comprising:
a light string comprising a plurality of LED emitters, the plurality of LED emitters electrically connected to one another such that they operate in response to receiving a voltage provided by a boost converter;
wherein the voltage provided by the boost converter is regulated by a driver.

16. The light array of claim 15, comprising a second light string comprising a second plurality of LED emitters, the second plurality of LED emitters electrically connected to one another such that they operate in response to receiving a second voltage provided by a boost converter.

17. The light array of claim 15, comprising a metallic substrate, wherein each of the plurality of LED emitters are disposed on the metallic substrate.

18. The light array of claim 17, comprising a temperature sensor disposed on the metallic substrate, the temperature sensor to generate a signal corresponding to a temperature of the metallic substrate.

19. The light array of claim 15, wherein the plurality of LED emitters are electrically connected in series.

20. A system for a boost driven light array comprising:
a boost converter comprising:
a boost circuit configured to output a predetermined output voltage higher than an input voltage;
wherein the boost circuit comprises a switched mode power supply;
a second boost circuit configured to output a second output voltage higher than the input voltage;
wherein the second boost circuit comprises a switched mode power supply; and
a current controller configured to maintain an output current of the boost converter to a predetermined current;
a light array comprising:
a plurality of LED light emitters disposed on a metallic substrate, the plurality of LED light emitters electrically connected in series;
a second plurality of LED light emitters, the second plurality of LED light emitters electrically connected in series; and
a temperature sensor disposed on the metallic substrate, the temperature sensor to generate a signal corresponding to a temperature of the metallic substrate; and
a driver electrically connected to the boost converter and the light array, the driver comprising a dimmer controller configured to regulate a power provided to the light array.
